(19) United States
(12) Patent Application Publication
(10) Pub. No.: US 2026/0362251 A1
(43) Pub. Date: Nov. 12, 2026

(54) LINK MANAGEMENT METHOD IN MULTI-ACCESS-POINT SYSTEM

(71) Applicant: MEDIATEK INC., Hsin-Chu (TW)

(72) Inventors: Chien-Fang Hsu, Hsinchu City (TW); Hao-Hua Kang, Hsinchu City (TW)

(73) Assignee: MEDIATEK INC., Hsin-Chu (TW)

(21) Appl. No.: 19/475,064

(22) PCT Filed: Jul. 30, 2024
(86) PCT No.: PCT/CN2024/108522

§ 371 Date: Oct. 14, 2025

Related U.S. Application Data
(60) Provisional application No. 63/516,572, filed on Jul. 31, 2023.
(60) Provisional application No. 63/520,111, filed on Aug. 17, 2023.

(51) Int. Cl. H04W 36/00; H04W 76/15

(52) U.S. Cl. CPC H04W 36/0069; H04W 76/15

(57) ABSTRACT

A link management method includes: generating a first request frame that is configured to request link switch for switching at least one link of a non-access-point station (non-AP STA) from a first access point (AP) in a multi-AP (MAP) system to a second AP in the MAP system, and sending the first request frame from the non-AP STA to one of the first AP and the second AP.

### BACKGROUND OF THE INVENTION

### 1. Field of the Invention

The present invention relates to wireless communications, and more particularly, to a link management method in a multi-access-point (MAP) system.

### 2. Description of the Prior Art

With development of the Wi-Fi technology, a MAP system is proposed. In the MAP system, there are multiple access points (APs) (e.g., AP multilink devices (MLDs)) coordinated to serve non-AP stations (STAs) (e.g., non-AP MLDs). When a non-AP STA (e.g., non-AP MLD) travels from a first position within a service area of a first AP (e.g., AP MLD) in the MAP system to a second position within a service area of a second AP (e.g., AP MLD) in the same MAP system, it is possible that the non-AP STA may want to switch link(s) from the first AP in the MAP system to the second AP in the same MAP system. How the frame is sent and exchanged during a link switch procedure needs to be addressed.

### SUMMARY OF THE INVENTION

One of the objectives of the claimed invention is to provide a link management method in a MAP system.

According to a first aspect of the present invention, an exemplary link management method is disclosed. The exemplary link management method includes: generating a first request frame that is configured to request link switch for switching at least one link of a non-AP STA from a first AP in a MAP system to a second AP in the MAP system, and sending the first request frame from the non-AP STA to one of the first AP and the second AP.

According to a second aspect of the present invention, an exemplary link management method is disclosed. The exemplary link management method includes: generating at least one request frame that is configured to request link deletion of at least one first link between a non-AP STA and a first AP in a MAP system and link addition of at least one second link between the non-AP STA and a second AP in the MAP system, and sending the at least one request frame from the non-AP STA to at least one of the first AP and the second AP.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a link switch scenario according to an embodiment of the present invention.

FIG. 2 is a diagram illustrating a wireless communication system that supports the proposed link management method according to an embodiment of the present invention.

FIG. 3 is a diagram illustrating a switch element in a request frame according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

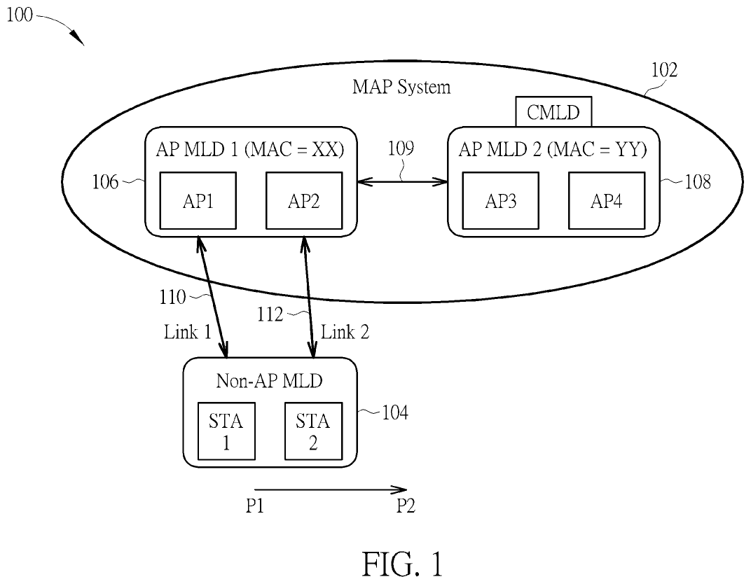

FIG. 1 is a diagram illustrating a link switch scenario according to an embodiment of the present invention. A wireless communication system 100 may be a Wi-Fi system compliant with IEEE 802.11be (Wi-Fi 7) standard, IEEE 802.11bn (Wi-Fi 8) standard or a next-generation Wi-Fi standard. The wireless communication system 100 includes a MAP system 102 that includes multiple APs. For brevity and simplicity, only two APs 106 and 108 are shown in FIG. 1. In addition, a non-AP STA 104 is associated with AP 106 of MAP system 102. It should be noted that an AP of the MAP system 102 may be an AP MLD which owns multiple links working on different radio-frequency (RF) bands and capable of operating at the same time, or may be a non-MLD AP. Hence, the MAP system 102 that supports the proposed link management method may be formed by multiple AP MLDs, multiple non-MLD APs, or a combination thereof. In this embodiment, the APs 106 and 108 are implemented by AP MLDs with different media access control (MAC) addresses (labeled by “AP MLD 1 (MAC=XX)” and “AP MLD 2 (MAC=YY)”), respectively. For example, one AP MLD may have two affiliated APs (labeled by “AP1” and “AP2”), and another AP MLD may have two affiliated APs (labeled by “AP3” and “AP4”). In addition, a common-MLD (CMLD) is embedded in one AP MLD to coordinate MAP operations between MLDs, including authentication, key distribution/update, etc. Multiple AP MLDs may be non-collocated and connected via a wired/wireless backhaul 109, and the CMLD acts as a centralized control device to coordinate them as a MAP system. In this embodiment, the non-AP STA 104 is implemented by a non-AP MLD that includes two affiliated STAs (labeled by “STA 1” and “STA 2”). Hence, the non-AP STA (e.g., non-AP MLD) 104 is connected to the AP (e.g., AP MLD) 106 through multiple links (labeled by “Link 1” and “Link 2”) 110 and 112. When the non-AP STA (e.g., non-AP MLD) 104 moves from a current location P1 to a different location P2, the non-AP STA (e.g., non-AP MLD) 104 may want to have link(s) switched from the AP (e.g., AP MLD) 106 to the AP (e.g., AP MLD) 108. It is possible that an AP, either source/serving AP (e.g., AP MLD) 106 or target AP (e.g., AP MLD) 108, or the MAP system 102 may send a request (or an instruction) to the non-AP STA (e.g., non-AP MLD) 104 to switch link(s) from the source/serving AP (e.g., AP MLD) 106 to the target AP (e.g., AP MLD) 108. While the non-AP STA (e.g., non-AP MLD) 104 accepts the request, it can initiate a link switch procedure according to the proposed link management method. Alternatively, it is possible that the non-AP STA (e.g., non-AP MLD) 104 is mandated to follow the request and initiate a link switch procedure according to the proposed link management method. The new link set up by the target AP (e.g., AP MLD) 108 may also initiate roaming of the non-AP STA (e.g., non-AP MLD) 104 from the source/serving AP (e.g., AP MLD) 106 to the target AP (e.g., AP MLD) 108.

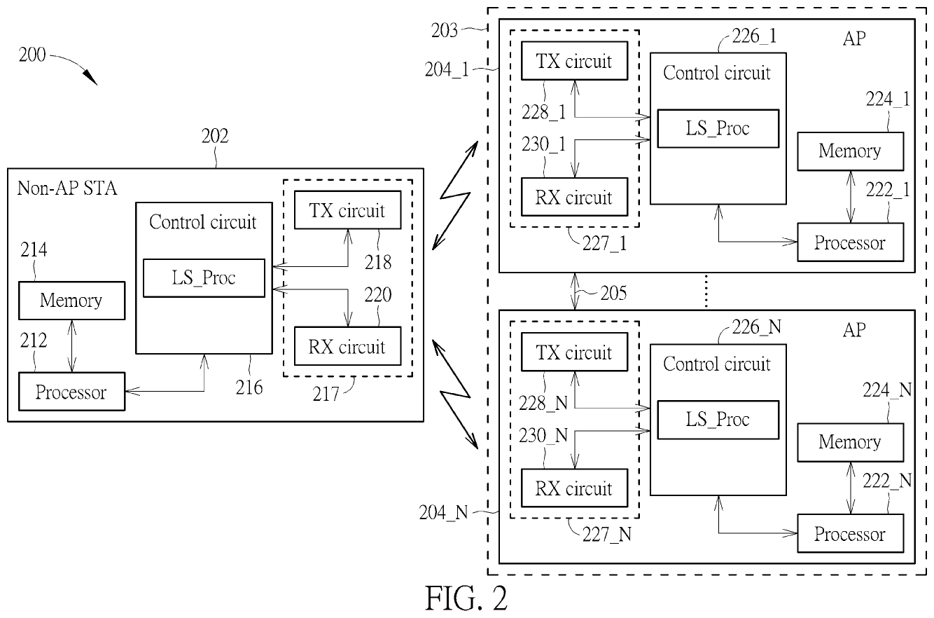

FIG. 2 is a diagram illustrating a wireless communication system that supports the proposed link management method according to an embodiment of the present invention. The wireless communication system 200 may be a Wi-Fi system compliant with IEEE 802.11be (Wi-Fi 7), IEEE 802.11bn (Wi-Fi 8) standard, or a next-generation Wi-Fi standard. The wireless communication system 200 includes a plurality of wireless communication devices, such as a non-AP STA 202 and multiple APs 204_1-204_N (N≥1), where the APs 204_1-204_N are within the same MAP system 203, and two of the APs 204_1-204_N can communication with each other through connection 205 such as a wired/wireless backhaul. The wireless communication system 100 shown in FIG. 1 may be realized by the wireless communication system 200, the MAP system 102 shown in FIG. 1 may be realized by the MAP system 203, the source/serving AP (e.g., AP MLD) 106 shown in FIG. 1 may be realized by the AP 204_1, the target AP (e.g., AP MLD) 108 shown in FIG. 1 may be realized by the AP 204_N, and the non-AP STA (e.g., non-AP MLD) 104 may be realized by the non-AP STA 202.

It should be noted that the non-AP STA 202 may be a non-AP MLD or a non-MLD STA, depending on actual application requirements, and the AP 204_1/204_N may be an AP MLD or a non-MLD AP, depending on actual application requirements. Hence, regarding the proposed switch management method, the terms “non-AP STA”, “non-AP MLD” and “non-MLD STA” may be interchangeable, and the terms “AP”, “AP MLD” and “non-MLD AP” may be interchangeable.

By way of example, but not limitation, non-AP 202 and APs 204_1-204_N may have the same or similar circuit structure. As shown in FIG. 2, non-AP STA 202/AP 204_1/AP 204_N includes a processor 212/222_1/222_N, a memory 214/224_1/224_N, a control circuit 216/226_1/226_N, and a network interface circuit 217/227_1/227 N, where the network interface circuit 217/227_1/227_N includes a transmitter (TX) circuit 218/228_1/228_N and a receiver (RX) circuit 220/230_1/230_N. In a case where the non-AP STA 202/AP 204_1/AP 204_N is an MLD, the TX circuit 218/228_1/228_N may include multiple TX chains for different RF bands, and the RX circuit 220/230_1/230_N may include multiple RX chains for different RF bands.

The memory 214/224_1/224_N is arranged to store a program code. The processor 212/222_1/222_N is arranged to load and execute the program code to manage the non-AP STA 202/AP 204_1/AP 204_N. The control circuit 216/226_1/226_N is arranged to control communications with other devices. For example, the control circuit 216/226_1/226_N controls the TX circuit 218/228_1/228_N of the network interface circuit 217/227_1/227_N to send packets (i.e., physical layer protocol data units (PPDUs)), and controls the RX circuit 220/222_1/222_N of the network interface circuit 217/227_1/227_N to receive packets (i.e., PPDUs), where one or more MAC frames (i.e., MAC layer protocol data units (MPDUs)) may be carried by the same packet (i.e., PPDU).

It should be noted that only the components pertinent to the present invention are illustrated in FIG. 2. In practice, each of non-AP 202 and APs 204_1-204_N may include additional components to achieve designated functions. The non-AP 202 and APs 204_1-204_N support the proposed link management method (labeled by “LS_Proc”).

In some embodiments of the present invention, the objective of switching link(s) of non-AP 202 from source/serving AP (e.g., AP 204_1) to target AP (e.g., AP 204_N) may be achieved by a link switch request. Hence, the non-AP 202 (e.g., non-AP MLD in FIG. 1) generates a request frame (e.g., an action frame) that is configured to request link switch for switching at least one link of the non-AP STA 202 from the source/serving AP 204_1 (e.g., AP MLD 1 in FIG. 1) in the MAP system 203 to the target AP 204_N (e.g., AP MLD 2 in FIG. 1) in the same MAP system 203, and sends the request frame to one of the source/serving AP 204_1 and the target AP 204_N.

Consider a first case where the non-AP 202 sends the request frame (i.e., link switch request) to the target AP 204_N (e.g., AP MLD 2 in FIG. 1). Link switching of one or more links owned by the non-AP 202 can be requested simultaneously. The request frame may carry necessary information (e.g., in a switch element) that is indicative of at least one of following parameters: an original link identifier (ID) of each of the at least one link between the non-AP STA 202 and the source/serving AP 204_1, an ID of the source/serving AP 204_1 (e.g., MLD ID of AP MLD 1), a target link ID of each of the at least one link between the non-AP STA 202 and the target AP 204_N, and mapping of the at least one link between the non-AP STA 202 and the source/serving AP 204_1 and the at least one link between the non-AP STA 202 and the target AP 204_N. In addition, the request frame may also carry necessary information (e.g., in a capability element distinct from the switch element, or in a sub-element of the switch element) that is to be set up with the target AP 204_N and indicative of at least one of following parameters: capabilities of each of the at least one link, operating parameters of each of the at least one link, and security key data. The information carried by the request frame can be checked and adopted directly within the target AP 204_N or a centralized control device (e.g., CMLD) that is arranged to coordinate MAP operations of the MAP system 203.

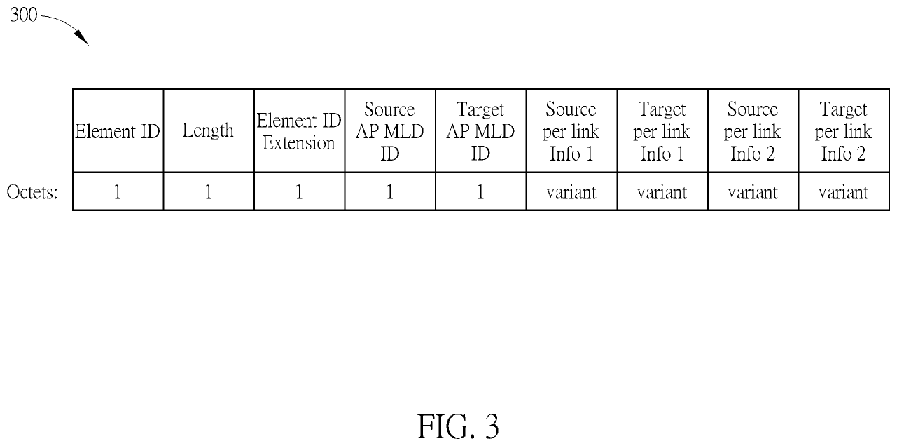

In some embodiments of the present invention, some or all of the above-mentioned information may be carried in a switch element 300 as shown in FIG. 3. The ID of the source/serving AP 204_1 (e.g., MLD ID of AP MLD 1) can be recorded in the “Source AP MLD ID” field. The ID of the target AP 204_N (e.g., MLD ID of AP MLD 2) can be recorded in the “Target AP MLD ID” field. Mapping of the at least one link between the non-AP STA 202 and the source/serving AP 204_1 and the at least one link between the non-AP STA 202 and the target AP 204_N can be recorded using the “Source per link info” and “Target per link info” pair(s), where each pair indicates 1 -on-1 mapping from a source link (i.e., a link between non-AP STA 202 and source/serving AP 204_1) to a target link (i.e., a link between non-AP STA 202 and target AP 204_N), and more than one pairs can be recorded. The “Source per link info” field may record a link ID of a source link between the non-AP STA 202 and the source/serving AP 204_1. The “Target per link info” field may record a link ID of a target link between the non-AP STA 202 and the target AP 204_N, and may optionally record capabilities to be used (which may be recorded in an independent capability element or a subelement of the switch element instead), operating parameters to be used (which may be recorded in an independent operation element or a subelement of the switch element instead), and security keys to be used (which may be retrieved from CMLD instead).

In some embodiments of the present invention, the keys to be used in the target AP 204 N can be obtained from a centralized control device (e.g., CMLD) that is arranged to coordinate MAP operations of the MAP system 203. In other words, the target AP 204_N may send a request of security key data to the centralized control device (e.g., CMLD), and then receive the security key data from the centralized control device (e.g., CMLD).

After receiving the request frame from the non-AP STA 202, the target AP 204_N may notify the source/serving AP 204_1 of link-related information (e.g., an original link ID of each of the at least one link between the non-AP STA 202 and the source/serving AP 204_1) through connection (e.g., wired/wireless backhaul) 205 between the source/serving AP 204_1 and the target AP 204_N.

Furthermore, after receiving the request frame from the non-AP STA 202, the target AP 204_N may send a response frame to the non-AP STA 202 for indicating an optional switch result (accepted, rejected, or partially accepted) of the link switch request. The target AP 204_N may not accept all the link switch request because of certain reasons, such as loading and capabilities to support the link.

Consider a second case where the non-AP 202 sends the request frame (i.e., link switch request) to the source/serving AP 204_1 (e.g., AP MLD 1 in FIG. 1). Link switching of one or more links owned by the non-AP 202 can be requested simultaneously. After receiving the request frame from the non-AP STA 202, the source/serving AP 204_1 may send a notification message (e.g., in the switch element 300 shown in FIG. 3) to notify the target AP 204_N of link-related information through connection (e.g., wired/wireless backhaul) 205 between the source/serving AP 204_1 and the target AP 204_N. For example, the notification message may carry necessary information that is indicative of at least one of following parameters: an original link ID of each of the at least one link between the non-AP STA 202 and the source/serving AP 204_1, an ID of the source/serving AP 204_1 (e.g., MLD ID of AP MLD 1), a target link ID of each of the at least one link between the non-AP STA 202 and the target AP 204_N, mapping of the at least one link between the non-AP STA 202 and the source/serving AP 204_1 and the at least one link between the non-AP STA 202 and the target AP 204_N, capabilities of each of the at least one link, operating parameters of each of the at least one link, and security key data.

The source/serving AP 204_1 may forward the link switch request to the target AP 204_N, and the target AP 204_N may send a message to the source/serving AP 204_1 for indicating if the target AP 204_N accepts the link switch request of the non-AP STA 202. Alternatively, the source/serving AP 204_1 may notify the CMLD of the link switch request, and the CMLD (which is a centralized control device that is arranged to coordinate MAP operations of the MAP system 203) makes decision on whether to accept the link switch request of the non-AP STA 202.

In some embodiments of the present invention, the keys to be used in the target AP 204_N can be obtained from a centralized control device (e.g., CMLD) that is arranged to coordinate MAP operations of the MAP system 203. In other words, the target AP 204_N may send a request of security key data to the centralized control device (e.g., CMLD), and then receive the security key data from the centralized control device (e.g., CMLD).

After receiving the request frame from the non-AP STA 202, the source/serving AP 204_1 may send a response frame to the non-AP STA 202 for indicating an optional switch result (accepted, rejected, or partially accepted) of the link switch request. The target AP 204_N may not accept all the link switch request because of certain reasons, such as loading and capabilities to support the link.

Furthermore, the target AP 204_N may optionally send an extra request frame to the non-AP STA 202 after the at least one link is successfully switched from the source/serving AP 204_1 to the target AP 204_N. For example, the extra request frame sent from the target AP 204_N is to check information (e.g., capabilities and operating parameters) of the at least one link. Hence, the non-AP STA 202 may send a response frame to the target AP 204_N to confirm or correct the information of the at least one link.

In above embodiments, a link management procedure is initialized by a link switch request. However, this is for illustrative purposes only, and is not meant to be a limitation of the present invention. In some embodiments of the present invention, the objective of switching link(s) of non-AP 202 from source/serving AP (e.g., AP 204_1) to target AP (e.g., AP 204_N) may be achieved by a link deletion request and a link addition request. Hence, the non-AP 202 (e.g., non-AP MLD in FIG. 1) generates at least one request frame (e.g., one or more action frames) configured to request link deletion of at least one source link between the non-AP STA 202 and the source/serving AP 204_1 (e.g., AP MLD 1 in FIG. 1) in the MAP system 203 and link addition of at least one target link between the non-AP STA 202 and the target AP 204_N (e.g., AP MLD 2 in FIG. 1) in the same MAP system 203, and sends the at least one request frame to only one of the source/serving AP 204_1 and the target AP 204_N. For example, two elements indicative of a link deletion request and a link addition request respectively may be carried in the same request frame. For another example, two elements indicative of a link deletion request and a link addition request respectively may be carried in two request frames that are aggregated in the same packet (i.e., PPDU). It should be noted that, since the link addition and link deletion can be controlled separately, the number of target links to be added to the target AP 204_N is not necessarily the same as the number of source links to be deleted from the source/serving AP 204_1.

Consider a first case where the non-AP 202 sends the request frame(s) (i.e., link deletion request and link addition) to the target AP 204_N (e.g., AP MLD 2 in FIG. 1). The request frame(s) may carry necessary deletion and addition information that is indicative of at least one of following parameters: an original link ID of each of the at least one source link between the non-AP STA 202 and the source/serving AP 204_1 (deletion), an ID of the source/serving AP 204_1 (e.g., MLD ID of AP MLD 1) (deletion), a target link ID of each of the at least one target link between the non-AP STA 202 and the target AP 204_N (addition), and mapping of the at least one source link between the non-AP STA 202 and the source/serving AP 204_1 and the at least one target link between the non-AP STA 202 and the target AP 204_N (optional). In addition, the request frame(s) may also carry necessary information that is to be set up with the target AP 204_N and indicative of at least one of following parameters: capabilities of each of the at least one target link, operating parameters of each of the at least one target link, and security key data. The information carried by the request frame(s) can be checked and adopted directly within the target AP 204_N or a centralized control device (e.g., CMLD) that is arranged to coordinate MAP operations of the MAP system 203.

In some embodiments of the present invention, the keys to be used in the target AP 204_N can be obtained from a centralized control device (e.g., CMLD) that is arranged to coordinate MAP operations of the MAP system 203. In other words, the target AP 204_N may send a request of security key data to the centralized control device (e.g., CMLD), and then receive the security key data from the centralized control device (e.g., CMLD).

After receiving the request frame(s) from the non-AP STA 202, the target AP 204_N may notify the source/serving AP 204_1 of link-related information (e.g., information of link deletion request) through connection (e.g., wired/wireless backhaul) 205 between the source/serving AP 204_1 and the target AP 204_N.

Furthermore, after receiving the request frame(s) from the non-AP STA 202, the target AP 204_N may send a response frame to the non-AP STA 202 for indicating an optional switch result (accepted, rejected, or partially accepted addition) of the link addition request and an optional switch result (accepted, rejected, or partially accepted deletion) of the link deletion request. It should be noted that a link's addition request and it associated link deletion request should be either accepted or rejected at the same time.

Consider a second case where the non-AP 202 sends the request frame(s) (i.e., link deletion request and link addition request) to the source/serving AP 204_1 (e.g., AP MLD 1 in FIG. 1). After receiving the request frame(s) from the non-AP STA 202, the source/serving AP 204_1 may send a notification message to notify the target AP 204_N of link-related information through connection (e.g., wired/wireless backhaul) 205 between the source/serving AP 204_1 and the target AP 204_N. For example, the notification message may carry necessary information that is indicative of at least one of following parameters: an original link ID of each of the at least one source link between the non-AP STA 202 and the source/serving AP 204_1, an ID of the source/serving AP 204_1 (e.g., MLD ID of AP MLD 1), a target link ID of each of the at least one target link between the non-AP STA 202 and the target AP 204_N, mapping of the at least one source link between the non-AP STA 202 and the source/serving AP 204_1 and the at least one target link between the non-AP STA 202 and the target AP 204_N, capabilities of each of the at least one target link, operating parameters of each of the at least one target link, and security key data.

The source/serving AP 204_1 may forward the link addition request to the target AP 204_N, and the target AP 204_N may send a message to the source/serving AP 204_1 to indicate if the target AP 204_N accepts the link addition request of the non-AP STA 202. Alternatively, the source/serving AP 204_1 may notify the CMLD of the link deletion request and the link addition request, and the CMLD (which is a centralized control device that is arranged to coordinate MAP operations of the MAP system 203) makes decision on whether to accept the link addition request and the link deletion request of the non-AP STA 202.

In some embodiments of the present invention, the keys to be used in the target AP 204_N can be obtained from a centralized control device (e.g., CMLD) that is arranged to coordinate MAP operations of the MAP system 203. In other words, the target AP 204_N may send a request of security key data to the centralized control device (e.g., CMLD), and then receive the security key data from the centralized control device (e.g., CMLD).

After receiving the request frame(s) from the non-AP STA 202, the source/serving AP 204_1 may send a response frame to the non-AP STA 202 for indicating an optional switch result (accepted, rejected, or partially accepted addition) of the link addition request and an optional switch result (accepted, rejected, or partially accepted deletion) of the link deletion request. It should be noted that a link's addition request and its associated link deletion request should be either accepted or rejected at the same time.

Furthermore, the target AP 204_N may optionally send an extra request frame to the non-AP STA 202 after the at least one target link is successfully added within the target AP 204_N. For example, the extra request frame sent from the target AP 204_N is to check information (e.g., capabilities and operating parameters) of the at least one target link. Hence, the non-AP STA 202 may send a response frame to the target AP 204_N to confirm or correct the information of the at least one target link.

In above embodiments, the link deletion request and the link addition request are sent at the same time due to being carried by two elements in the same frame or carried by two frames aggregated in the same PPDU. However, this is for illustrative purposes only, and is not meant to be a limitation of the present invention. In some embodiments of the present invention, the non-AP 202 (e.g., non-AP MLD in FIG. 1) generates a first request frame (e.g., one action frame) configured to request link deletion of at least one source link between the non-AP STA 202 and the source/serving AP 204_1 (e.g., AP MLD 1 in FIG. 1) in the MAP system 203 and a second request frame (e.g., another action frame) configured to request link addition of at least one target link between the non-AP STA 202 and the target AP 204_N (e.g., AP MLD 2 in FIG. 1) in the same MAP system 203, sends the first request frame to one of the source/serving AP 204_1 and the target AP 204_N, and sends the second request frame to another of the source/serving AP 204_1 and the target AP 204_N. For example, the first request frame (i.e., link deletion request) can be sent first, and the second request frame (i.e., link addition request) can be sent later. For another example, the second request frame (i.e., link addition request) can be sent first, and the first request frame (i.e., link deletion request) can be sent later.

The first request frame (i.e., link deletion request) and the second request frame (i.e., link addition request) are sent separately. In one exemplary design, the non-AP STA 202 may send the first request frame (i.e., link deletion request) to the source/serving AP 204_1, and may send the second request frame (i.e., link addition request) to the target AP 204_N. In another exemplary design, the non-AP STA 202 may send the first request frame (i.e., link deletion request) to the target AP 204_N, and may send the second request frame (i.e., link addition request) to the source/serving AP 204_1. After receiving the first request frame (i.e., link deletion request), the target AP 204_N may forward the first request frame (i.e., link deletion request) to the source/serving AP 204_1. After receiving the second request frame (i.e., link addition request), the source/serving AP 204_1 may forward the second request frame (i.e., link addition request) to the target AP 204_N.

After receiving the first request frame (i.e., link deletion request) from the non-AP STA 202, one AP may send a first response frame to the non-AP STA 202 for indicating an optional switch result (accepted, rejected, or partially accepted deletion) of the link deletion request. In addition, after receiving the second request frame (i.e., link addition request) from the non-AP STA 202, another AP may send a second response frame to the non-AP STA 202 for indicating an optional switch result (accepted, rejected, or partially accepted addition) of the link addition request.

During a link management procedure in which a link of a non-AP MLD is switched to a target AP MLD, it may consume a lot of bandwidth to exchange the link's information, including capabilities and operation parameters. It is possible that some information is static and can be saved/registered in the MAP system so that only a portion of the updated information is needed to be sent to the target AP MLD. Based on such observation, the present invention further proposes an information exchange load reduction scheme. For example, when a non-AP MLD associates with an AP MLD of an MAP system, it registers a set of parameters (e.g., capabilities and operation parameters of each link). Hence, the CMLD can save those parameters and distribute them to an AP MLD of the MAP system when necessary or by requested. In addition, a unique link ID of a link is required to identify this link's parameters (e.g., capabilities and operation parameters). The unique link ID is different from the link ID of the AP MLD or the MAP system. The registered/pre-stored parameters serve as the base information of each link owned by the non-AP MLD. When the non-AP MLD switches a link to a target AP MLD, the unique link ID of the non-AP MLD can be used to indicate what parameters to be used after the link switch. The target AP MLD may have saved those parameters or may send a request to CMLD to retrieve them. Optionally, when the non-AP MLD needs to update certain parameters, only the updated parameters are required to complete the link switch procedure.

Regarding the aforementioned embodiment of switching link(s) of non-AP 202 from source/serving AP 204_1 to target AP 204_N by sending a link switch request, the target AP 204_N may use a unique link ID of each switched link to retrieve pre-stored parameters (e.g., capabilities and operation parameters) of the switched link, wherein the pre-stored parameters are not carried via the request frame that carries information of the link switch request. In this way, the bandwidth occupied by information exchange during the link switch procedure can be effectively reduced.

Regarding the aforementioned embodiment of switching link(s) of non-AP 202 from source/serving AP 204_1 to target AP 204_N by sending a link deletion request and a link addition request, the target AP 204_N can use a unique link ID of each added link to retrieve pre-stored parameters (e.g., capabilities and operation parameters) of the added link, wherein the pre-stored parameters are not carried via request frame(s) configured to request link deletion and link addition. In this way, the bandwidth occupied by information exchange during the link switch procedure can be effectively reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A link management method comprising:
generating a first request frame that is configured to request link switch for switching at least one link of a non-access-point station (non-AP STA) from a first access point (AP) in a multi-AP (MAP) system to a second AP in the MAP system; and
sending the first request frame from the non-AP STA to one of the first AP and the second AP.

2. The link management method of claim 1, wherein the first request frame is configured to carry information indicative of at least one of following parameters:
an original link identifier of each of the at least one link between the non-AP STA and the first AP;
an identifier of the first AP;
a target link identifier of each of the at least one link between the non-AP STA and the second AP;
mapping of the at least one link between the non-AP STA and the first AP and the at least one link between the non-AP STA and the second AP;
capabilities of each of the at least one link;
operating parameters of each of the at least one link; and
security key data.

3. The link management method of claim 1, further comprising:
using a unique link identifier of each of the at least one link to retrieve pre-stored parameters of said each of the at least one link, wherein the pre-stored parameters are not carried via the first request frame.

4. The link management method of claim 1, further comprising:
notifying another of the first AP and the second AP of link-related information through connection between the first AP and the second AP.

5. The link management method of claim 1, further comprising:
receiving, by the second AP, security key data from a centralized control device that is arranged to coordinate MAP operations of the MAP system.

6. The link management method of claim 1, further comprising:
sending a response frame from said one of the first AP and the second AP to the non-AP STA, where the response frame indicates that the link switch of the at least one link is accepted, rejected, or partially accepted.

7. The link management method of claim 1, wherein sending the first request frame from the non-AP STA to said one of the first AP and the second AP comprises:
sending the first request frame to the second AP.

8. The link management method of claim 1, wherein sending the first request frame from the non-AP STA to said one of the first AP and the second AP comprises:
sending the first request frame to the first AP.

9. The link management method of claim 8, further comprising:
after the at least one link is successfully switched from the first AP to the second AP, sending a second request frame from the second AP to the non-AP STA to check information of the at least one link; and
sending a response frame from the non-AP STA to the second AP to confirm or correct the information of the at least one link.

10. A link management method comprising:
generating at least one request frame that is configured to request link deletion of at least one first link between a non-access-point station (non-AP STA) and a first access point (AP) in a multi-AP (MAP) system and link addition of at least one second link between the non-AP STA and a second AP in the MAP system; and
sending the at least one request frame from the non-AP STA to at least one of the first AP and the second AP.

11. The link management method of claim 10, wherein the at least one request frame is configured to carry information indicative of at least one of following parameters:
an original link identifier of each of the at least one first link between the non-AP STA and the first AP;
an identifier of the first AP;
a target link identifier of each of the at least one second link between the non-AP STA and the second AP;
mapping of the at least one first link between the non-AP STA and the first AP and the at least one second link between the non-AP STA and the second AP;
capabilities of each of the at least one second link;
operating parameters of each of the at least one second link; and
security key data.

12. The link management method of claim 10, further comprising:
using a unique link identifier of each of the at least one second link to retrieve pre-stored parameters of said each of the at least one second link, wherein the pre-stored parameters are not carried via the at least one request frame.

13. The link management method of claim 10, further comprising:
receiving, by the second AP, security key data from a centralized control device that is arranged to coordinate MAP operations of the MAP system.

14. The link management method of claim 10, wherein sending the at least one request frame from the non-AP STA to the at least one of the first AP and the second AP comprises:
sending the at least one request frame from the non-AP STA to one of the first AP and the second AP only.

15. The link management method of claim 14, further comprising:
notifying another of the first AP and the second AP of link-related information through connection between the first AP and the second AP.

16. The link management method of claim 14, wherein sending the at least one request frame from the non-AP STA to said one of the first AP and the second AP comprises:
sending the at least one request frame from the non-AP STA to the second AP.

17. The link management method of claim 14, wherein sending the at least one request frame from the non-AP STA to one of the first AP and the second AP comprises:
sending the at least one request frame from the non-AP STA to the first AP.

18. The link management method of claim 17, further comprising:
after the at least one second link is successfully added within the second AP, sending another request frame from the second AP to the non-AP STA to check information of the at least one second link; and
sending a response frame from the non-AP STA to the second AP to confirm or correct the information of the at least one second link.

19. The link management method of claim 10, further comprising:
sending at least one response frame from the at least one of the first AP and the second AP to the non-AP STA, where the at least one response frame indicates that the link addition of the at least one second link is accepted, rejected, or partially accepted, or indicates that the link deletion of the at least one first link is accepted, rejected, or partially accepted.

20. The link management method of claim 10, wherein the at least one request frame comprises a first request frame configured to request the link deletion of the at least one first link and a second request frame configured to request the link addition of the at least one second link; and sending the at least one request frame from the non-AP STA to the at least one of the first AP and the second AP comprises:
sending the first request frame to the first AP; and
sending the second request frame to the second AP.

21. The link management method of claim 10, wherein the at least one request frame comprises a first request frame configured to request the link deletion of the at least one first link and a second request frame configured to request the link addition of the at least one second link; and sending the at least one request frame from the non-AP STA to the at least one of the first AP and the second AP comprises:
sending the first request frame to the second AP;
sending the second request frame to the first AP;
forwarding a link deletion request from the second AP to the first AP; and
forwarding a link addition request from the first AP to the second AP.
